(19) United States
(12) Patent Application Publication
(10) Pub. No.: US 2026/0273711 A1
(43) Pub. Date: Sep. 17, 2026

(54) NAIL GUN ADAPTABLE TO MULTIPLE OPERATING CONDITIONS AND FACILITATING MAINTENANCE, AND METHOD

(71) Applicant: HANGZHOU KELONG ELECTRIC DEVICES CO., LTD., Hangzhou (CN)

(72) Inventors: Wenping LIU, Hangzhou (CN); Guomin YAN, Hangzhou (CN)

(73) Assignee: HANGZHOU KELONG ELECTRIC DEVICES CO., LTD., Hangzhou (CN)

(21) Appl. No.: 19/674,065

(22) Filed: May 11, 2026

Related U.S. Application Data
(63) Continuation of application No. PCT/CN2023/133252, filed on Nov. 22, 2023.

(30) Foreign Application Priority Data
Nov. 15, 2023 (CN) 202311524106.7

(51) Int. Cl. B25C 1/04

(52) U.S. Cl. CPC B25C 1/047; B25C 1/042; B25C 1/043

(57) ABSTRACT

Disclosed is a nail gun adaptable to multiple operating conditions and facilitating maintenance and a method. The nail gun includes a housing assembly including a gun housing, an assembly frame, and a gun body top cover; an energy storage chamber including a large air cylinder and a small air cylinder, a cylinder head detachably mounted at the rear end of the large air cylinder, a cylinder head base mounted at the front end thereof, and a through hole at the rear end of the small air cylinder communicating with the large air cylinder; a firing pin assembly including a firing pin body and a piston; the cylinder head base including a cylinder connecting cover and a motor connecting sleeve, the assembly frame fixed to the cylinder head base; and a drive cam unidirectionally driven by a motor, driving the piston to compress the gas in the energy storage chamber.

### CROSS-REFERENCE TO RELATED APPLICATIONS

The present patent document is a continuation of PCT/CN2023/133252, filed November 22, 2023, which claims the benefit of priority to Chinese Patent Application No. 202311524106.7, filed November 15, 2023, and entitled “Nail Gun Adaptable to Multiple Operating Conditions and Facilitating Maintenance, and Method,” the entire contents of each of which are incorporated herein by reference.

### TECHNICAL FIELD

The present disclosure relates to the field of nail guns, and in particular, to a nail gun adaptable to multiple operating conditions and facilitating maintenance, and a method.

### BACKGROUND

In the market for nail guns, a nail gun is both a professional-grade tool and a device suitable for ordinary households and individuals for simple decoration and renovation tasks. Existing nail guns are generally not adaptable to nails of various specifications and sizes, and, in the event of a malfunction, typically require complete disassembly of the entire nail gun for repair and maintenance. For non-professional users (e.g., household users), such disassembly and maintenance are relatively difficult, resulting in a poor user experience. If, during use, a single nail gun can satisfy consumers’ needs by allowing replacement of working components of different models, specifications, and sizes, or adjustment of air pressure to match different operating conditions (such as wooden boards or walls of different materials, nails of different lengths or specifications, and corresponding matching of the firing pin assembly in terms of specification and size, as well as significant variations in required driving force necessitating corresponding adjustment of the pressure within an energy storage chamber), without requiring complete disassembly of the nail gun but only partial opening of certain components (such as a gun body top cover, a decorative cover, or a cylinder head), the user experience would be greatly improved. In this way, it is possible to avoid, for example, over-penetration of soft media (such as short or thin nails) through wooden boards or walls, and insufficient driving of nails into wooden boards or walls when working with hard media (such as long or thick nails). It also enables proper matching of the firing pin assembly with nails of different specifications and sizes, and facilitates convenient and easy replacement and maintenance when vulnerable internal components of the nail gun are damaged or malfunctioning. Accordingly, the flexibility of use of the nail gun is enhanced, and the overall user experience is improved.

### SUMMARY

An objective of the present disclosure is to provide a nail gun adaptable to multiple operating conditions and facilitating maintenance and a method, so as to overcome the shortcomings of the existing technology. This allows replacement of working components of different models, specifications, and sizes, or adjustment of air pressure to match different operating conditions, without requiring complete disassembly of the nail gun but only partial exposure of certain components, thereby facilitating convenient and easy replacement and maintenance when vulnerable internal components of the nail gun are damaged or malfunctioning.

The objective of the present disclosure is achieved through the following technical proposal: a nail gun adaptable to multiple operating conditions and facilitating maintenance, including:

a housing assembly including a gun housing, an assembly frame disposed at a front end of the gun housing, and a gun body top cover detachably mounted on a rear end of the gun housing, a nail magazine being connected to a lower part of the assembly frame;

an energy storage chamber including a large air cylinder disposed inside the gun housing and a small air cylinder inserted inside the large air cylinder, a cylinder head being detachably mounted at a rear end of the large air cylinder and configured to press and seal a rear end of the small air cylinder, a cylinder head base being mounted at a front end of the large air cylinder for sealing, and a front end of the small air cylinder being abutted against the cylinder head base, a through hole communicating with the large air cylinder being opened at a rear end of the small air cylinder, so that the large air cylinder and the small air cylinder cooperate to form the energy storage chamber which is closed;

a firing pin assembly including a firing pin body and a piston fixed to a rear end of the firing pin body, the piston being slidably disposed in the energy storage chamber, so as to adjust an air pressure in the energy storage chamber between an initial pressure and an energy storage pressure, a front end of the firing pin body passing through the cylinder head base and extending into the assembly frame for striking a nail in the assembly frame;

the cylinder head base including a cylinder connecting cover detachably connected to the large air cylinder and a motor connecting sleeve for connecting a motor, the assembly frame being fixed to the cylinder head base; and

a drive cam driven unidirectionally by the motor and being provided with a plurality of cam pin shafts, the cam pin shafts being configured to engage with firing pin teeth arranged on the firing pin body, thereby driving the piston to compress the gas in the energy storage chamber.

The gun body top cover is configured to, when removed, expose the cylinder head from the rear end of the gun housing; a valve core is mounted on the cylinder head to communicate an external environment with the energy storage chamber and adjust the initial pressure in the energy storage chamber; the cylinder head is configured to, when removed, expose the small air cylinder from the rear end of the large air cylinder, thereby facilitating removal or replacement of the small air cylinder and firing pin assembly.

As a further technical proposal, a buffer pad is disposed between the cylinder connecting cover and the small air cylinder for providing cushioning to the piston; the buffer pad and the cylinder connecting cover are each provided with a firing pin slot through which the firing pin body passes and extends into a firing pin track in the assembly frame.

As a further technical proposal, the cylinder connecting cover is provided with a plurality of cylinder head base holes, and bosses are arranged on an end face of the buffer pad and configured to be embedded and mounted in the cylinder head base holes; at least one of the cylinder head base holes close to the decorative cover is formed as a through hole, serving as a cylinder head base ejection hole; the decorative cover is detachably mounted between the gun housing and the assembly frame and, when removed, exposes the cylinder connecting cover through the cylinder head base ejection hole, thereby facilitating ejection of the buffer pad.

As a further technical proposal, a gearbox is arranged inside the motor connecting sleeve; an output end of the motor is configured to transmit power to a camshaft after being reduced by the gearbox; a one-way bearing is sleeved on the camshaft so that the drive cam is maintained in unidirectional rotation.

As a further technical proposal, a mode switching setting switch is mounted on the surface of the gun housing, and a control circuit board is mounted inside the gun housing; the mode switching setting switch is electrically connected to the control circuit board and is configured to set an operating position and send an operating position signal to the control circuit board; the operating position includes a normal operating position and a maintenance position; in the normal operating position, after the firing pin assembly is fully released, the gas in the energy storage chamber returns to the initial pressure, the control circuit board controls the drive cam to drive the firing pin assembly so as to compress and pressurize the gas in the energy storage chamber, and the control circuit board controls the drive cam to stop rotating when the pressure reaches the energy storage pressure, and the firing pin assembly is held in a preset position by the one-way bearing to maintain the energy storage pressure; in the maintenance position, after the firing pin assembly is fully released, the control circuit board controls the drive cam to stop operating, and the gas in the energy storage chamber remains at the initial pressure.

As a further technical proposal, the front end of the large air cylinder is provided with an internal thread that cooperates with an external thread on the cylinder connecting cover; and a plurality of lugs are evenly arranged along a circumferential direction on an outer wall of the rear end of the large air cylinder, each provided with a connecting hole for cooperating with cylinder head screws arranged on the cylinder head.

As a further technical proposal, an end of the valve core is communicated with an inner cavity of the small air cylinder, and the other end of the valve core is communicated with the external environment and sealed with a valve core sealing cap; a cylinder head sealing ring is mounted on an inner side of the cylinder head to cooperate in sealing the end face of the large air cylinder.

As a further technical proposal, a small air cylinder sealing groove is provided on an outer wall at the front end of the small air cylinder for receiving a small air cylinder sealing ring, and the small air cylinder sealing ring is in contact with the inner wall of the large air cylinder in a sealing manner; a plurality of through holes are evenly distributed along the circumferential direction on an outer wall at the rear end of the small air cylinder, and a step is arranged along an circumferential direction on an inner side of the through holes, so that an inner diameter of the small air cylinder at the through holes is larger than an inner diameter thereof at the step.

A method for adapting and maintaining a nail gun to multiple operating conditions, employing the aforementioned nail gun adaptable to multiple operating conditions and facilitating maintenance, includes the following operating modes:

a normal operating mode: when the mode switching setting switch is set to the normal operating position and the trigger of the nail gun is actuated, after the firing pin assembly is fully released, the gas in the energy storage chamber returns to the initial pressure, the control circuit board controls the drive cam to drive the firing pin assembly so as to compress and pressurize the gas in the energy storage chamber; when the pressure reaches the energy storage pressure, the control circuit board controls the drive cam to stop rotating, and the one-way bearing holds the firing pin assembly at the preset position to maintain the energy storage pressure, upon a subsequent actuation of the trigger of the nail gun, the firing pin assembly is released to strike the nail, thereby enabling cyclic operation;

an adaptation mode: when the mode switching setting switch is set to the maintenance position and the trigger of the nail gun is actuated, after the firing pin assembly is fully released, the control circuit board controls the drive cam to stop operating and disengage from the firing pin assembly, such that the drive cam no longer drives the firing pin assembly to return, the gas in the energy storage chamber is maintained at the initial pressure, at this time, the gun body top cover is removed and the valve core sealing cap on the cylinder head is unscrewed to release the valve core, thereby releasing the gas in the energy storage chamber, an external air source is connected to the valve core to inflate the energy storage chamber, and the inflation pressure is adjusted according to the actual operating conditions to change the initial pressure in the energy storage chamber, after completion, the valve core sealing cap is tightened, the gun body top cover is mounted, and the mode switching setting switch is returned to the normal operating position;

a maintenance mode: when the mode switching setting switch is set to the maintenance position and the trigger of the nail gun is actuated, after the firing pin assembly is fully released, the control circuit board controls the drive cam to stop operating and disengage from the firing pin assembly, such that the drive cam no longer drives the firing pin assembly to return, the gas in the energy storage chamber is maintained at the initial pressure, at this time, the gun body top cover and the decorative cover are removed, and the valve core sealing cap is unscrewed to release the valve core, thereby releasing the gas in the energy storage chamber, then the cylinder head is opened, and the small air cylinder, the firing pin assembly, and the buffer pad in the energy storage chamber are sequentially removed for replacement; during assembly, the buffer pad is first mounted, then the small air cylinder is inserted into the large air cylinder, and the firing pin assembly is mounted and pushed fully into position, then the cylinder head is mounted, and the energy storage chamber is inflated via the valve core, after inflation, the valve core sealing cap is tightened, the gun body top cover and the decorative cover are mounted, and the mode switching setting switch is returned to the normal operating position.

As a further technical proposal, in the adaptation mode, an inflation pressure for driving a hard material and a long nail is greater than an inflation pressure for driving a soft material and a short nail; in the maintenance mode, the small air cylinder is removed by engaging a tool with the through hole and pulling the small air cylinder along an axial direction.

The advantageous effects of the present disclosure are as follows:
1. The gun body top cover and the cylinder head are detachably arranged, such that when the cylinder head sealing ring fails, the small air cylinder is worn, the firing pin assembly is damaged, the buffer pad is cracked, or the small air cylinder sealing ring fails, these parts can be easily replaced, allowing the nail gun to resume normal operation and thereby significantly extending the service life of the nail gun;
2. The nail gun is adaptable to different operating conditions with components of different models, specifications and sizes: for driving hard materials, long nails or thick nails, a large air cylinder having a larger cylinder diameter is used, together with a corresponding firing pin assembly of greater strength and/or of different specifications and sizes, as well as a corresponding buffer pad; for driving soft materials and short or thin nails, a small air cylinder having a smaller cylinder diameter is used, together with a corresponding firing pin assembly of relatively lower strength and/or of different specifications and sizes, as well as a corresponding buffer pad. Moreover, the energy storage chamber can be inflated via the valve core, and the inflation pressure can be appropriately adjusted according to the operating conditions, thereby enabling optimal adaptation to different operating conditions;
3. The mode switching setting switch provided on the gun housing allows for flexible adjustment of the operating mode;
4. A cylinder head base ejection hole is provided on the cylinder connecting cover to eject the buffer pad for easy replacement;
5. The inner diameter of the small air cylinder at the through hole is larger than the inner diameter at the step, when removing the small air cylinder by engaging a tool with the through hole, the radial surface of the cylinder is not damaged, thus extending the service life of the small air cylinder.

### BRIEF DESCRIPTION OF THE DRAWINGS

FIG. 1 is a front structural view of the present disclosure.

FIG. 2 is a cross-sectional view along line AA of FIG. 1.

FIG. 3 is a top structural view of the present disclosure.

FIG. 4 is a cross-sectional view along line BB of FIG. 3.

FIG. 5 is a first schematic diagram of the cylinder head in the present disclosure.

FIG. 6 is a second schematic diagram of the cylinder head in the present disclosure.

FIG. 7 is a first schematic diagram of the large air cylinder in the present disclosure.

FIG. 8 is a second schematic diagram of the large air cylinder in the present disclosure.

FIG. 9 is a perspective structural view of the small air cylinder in the present disclosure.

FIG. 10 is a cross-sectional structural view of the small air cylinder in the present disclosure.

FIG. 11 is a schematic diagram of the assembly structure of the motor, the gearbox, the one-way bearing and the drive cam in the present disclosure.

FIG. 12 is a first schematic diagram of the assembly structure of the motor, the cylinder head base, and the assembly frame in the present disclosure.

FIG. 13 is a second schematic diagram of the assembly structure of the motor, the cylinder head base, and the assembly frame in the present disclosure.

FIG. 14 is a schematic diagram of the cylinder head base in the present disclosure.

FIG. 15 is a schematic diagram of the buffer pad in the present disclosure.

FIG. 16 is a schematic diagram of the structure with the gun body top cover and the cylinder head removed in the present disclosure.

FIG. 17 is a schematic diagram of the structure with the gun body top cover, the cylinder head and the decorative cover removed in the present disclosure.

FIG. 18 is a schematic diagram of the method flow of the present disclosure.

Reference signs are as follows: gun body top cover 1; top cover screw 1-1; gun housing 2; mode switching setting switch 3; control circuit board 4; nail magazine 5; motor 6; gearbox 7; one-way bearing 8; decorative cover 9; decorative cover screw 9-1; cylinder head 10; valve core 10-1; valve core sealing cap 10-2; cylinder head screw 10-3; cylinder head sealing ring 10-4; large air cylinder 11; internal thread 11-1; lug 11-2; connecting hole 11-3; small air cylinder 12; small air cylinder sealing ring 12-1; small air cylinder sealing groove 12-2; through hole 12-3; step 12-4; firing pin assembly 13; piston 13-1; firing pin body 13-2; firing pin teeth 13-3; optocoupler sensing notch 13-4; drive cam 14; camshaft 14-1; cam pin shaft 14-2; assembly frame 15; firing pin track 15-1; sensing optocoupler 16; clutch pawl 17; pawl toggling handle 17-1; pawl head 17-2; cylinder head base 18; cylinder connection cover 18-1; motor connecting sleeve 18-2; cylinder head base ejection hole 18-3; external thread 18-4; firing pin slot 18-5; buffer pad 19; and boss 19-1.

### DETAILED DESCRIPTION OF EMBODIMENTS

The present disclosure will now be described in detail with reference to the accompanying drawings.

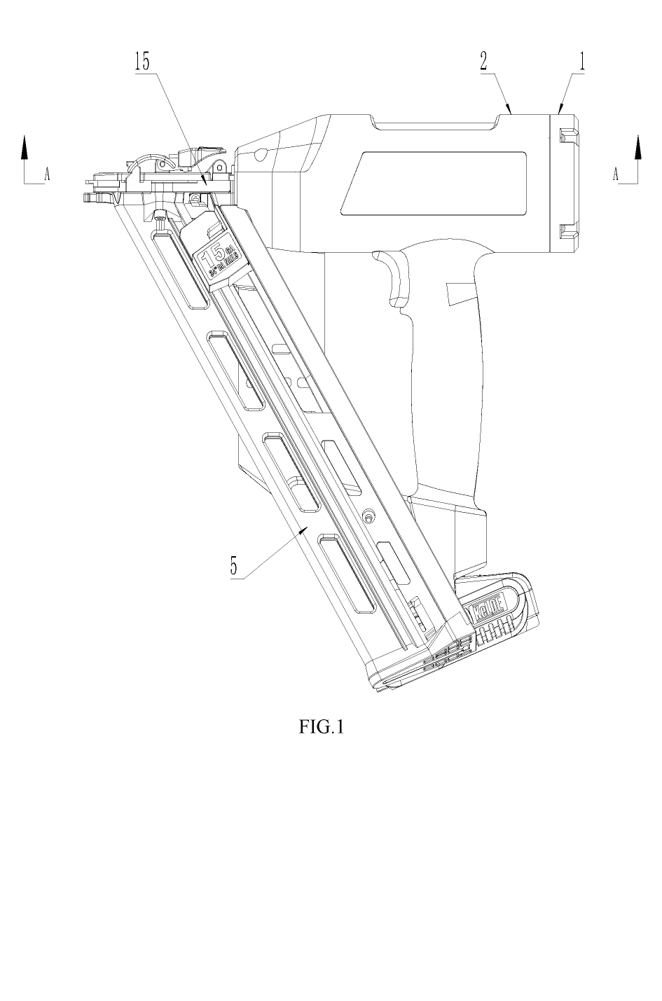

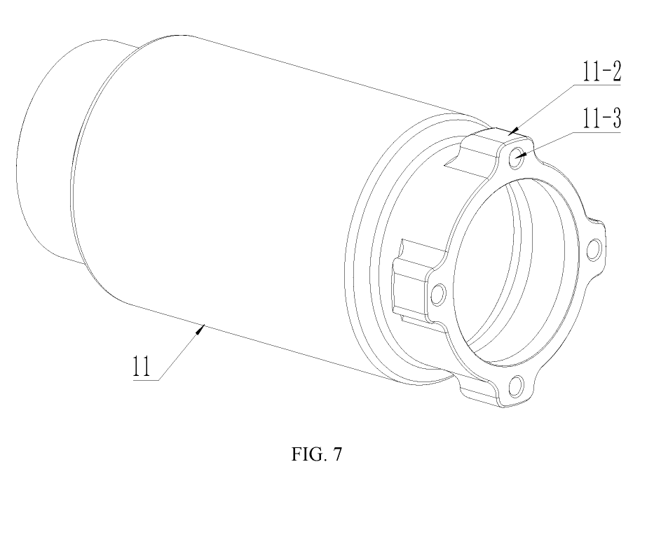

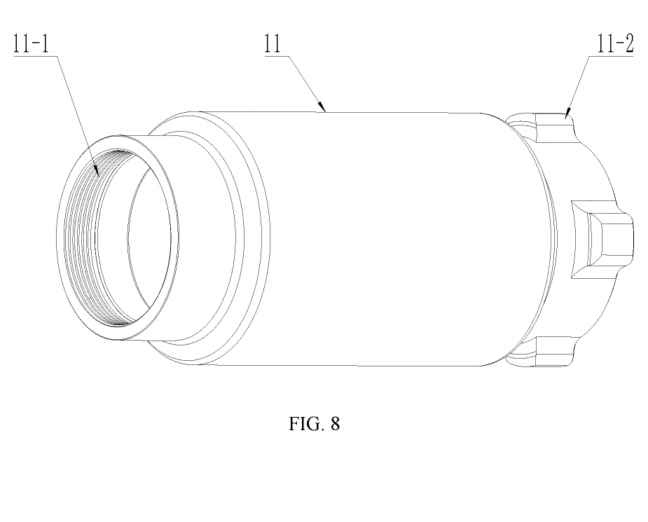

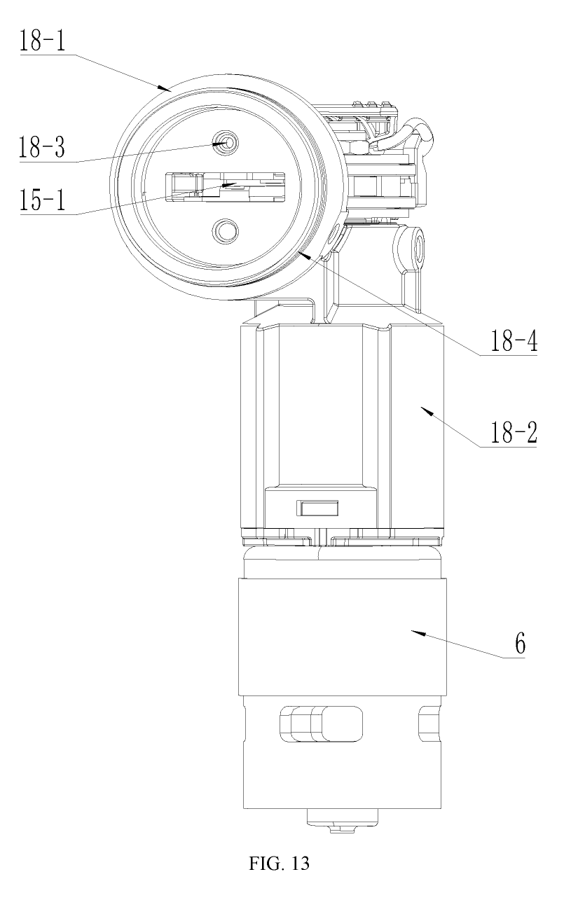

In an embodiment, as shown in FIGS. 1-17, the nail gun adaptable to multiple operating conditions and facilitating maintenance includes: a gun body top cover 1, a top cover screw 1-1, a gun housing 2, a mode switching setting switch 3, a control circuit board 4, a nail magazine 5, a motor 6, a gearbox 7, a one-way bearing 8, a decorative cover 9, a decorative cover screw 9-1, a cylinder head 10, a valve core 10-1, a valve core sealing cap 10-2, a cylinder head screw 10-3, a cylinder head sealing ring 10-4, a large air cylinder 11, an internal thread 11-1, a lug 11-2, a connecting hole 11-3, a small air cylinder 12, a small air cylinder sealing ring 12-1, a small air cylinder sealing groove 12-2, a through hole 12-3, a step 12-4, a firing pin assembly 13, a piston 13-1, a firing pin body 13-2, firing pin teeth 13-3, an optocoupler sensing notch 13-4, a drive cam 14, a camshaft 14-1, a cam pin shaft 14-2, an assembly frame 15, a firing pin track 15-1, a sensing optocoupler 16, a clutch pawl 17, a pawl toggling handle 17-1, a pawl head 17-2, a cylinder head base 18, a cylinder connecting cover 18-1, a motor connecting sleeve 18-2, a cylinder head base ejector hole 18-3, an external thread 18-4, a firing pin slot 18-5, a buffer pad 19 and a boss 19-1.

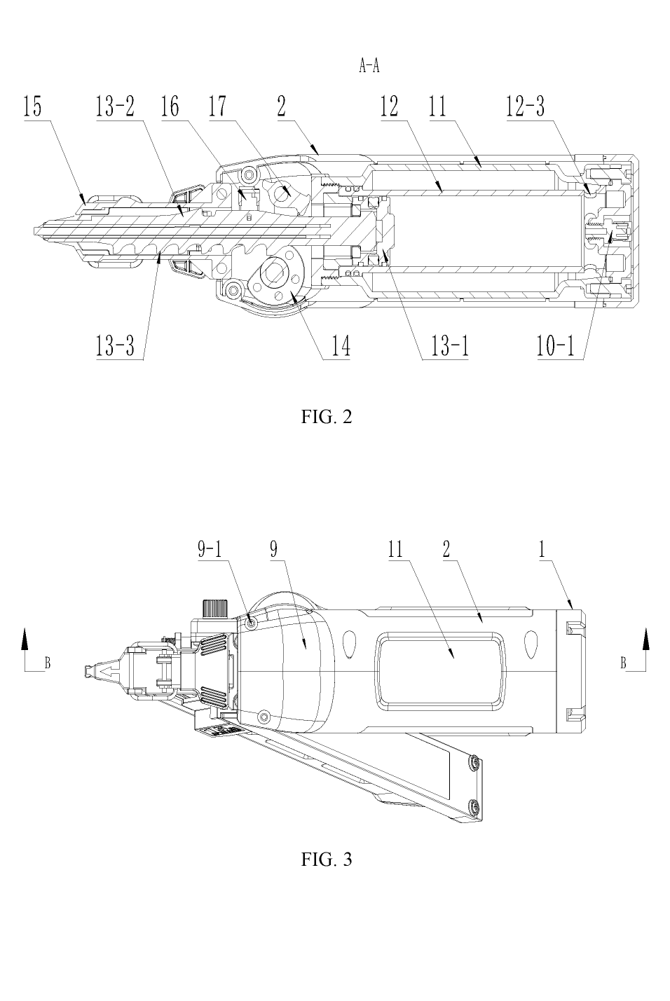

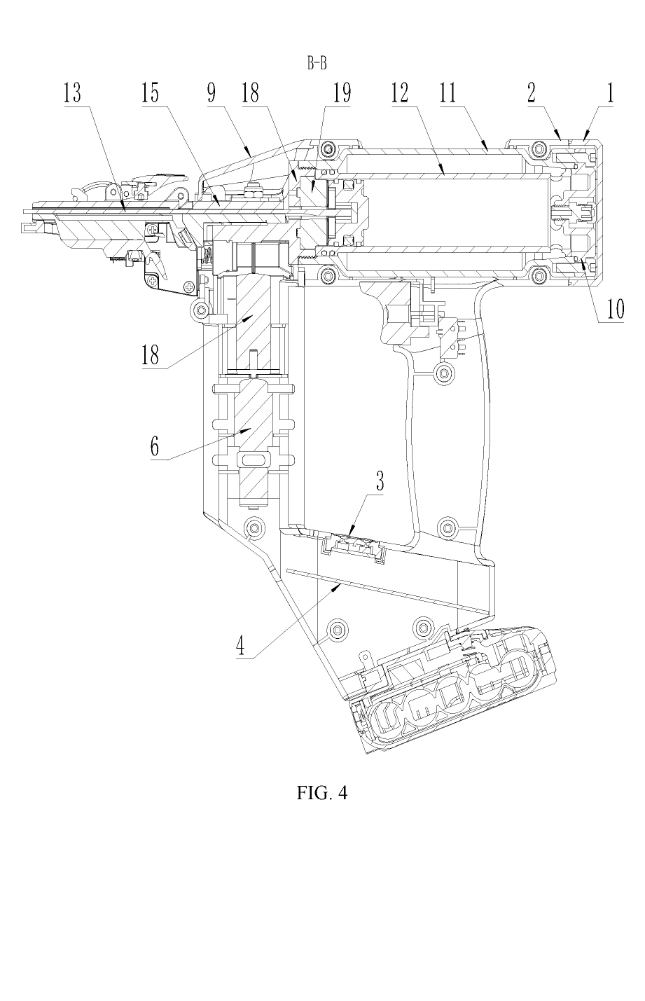

Referring to FIGS. 2 and 4, an assembly frame 15 is provided at the front end of the gun housing 2, and a top cover 1 is detachably mounted at the rear end of the gun housing 2 via a top cover screw 1-1. A nail magazine 5 is connected to the lower part of the assembly frame 15. The gun housing 2, the gun body top cover 1, and the assembly frame 15 together constitute the housing assembly of the nail gun.

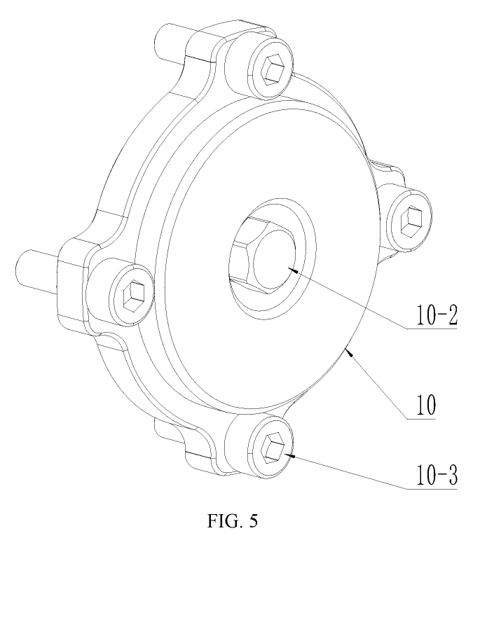

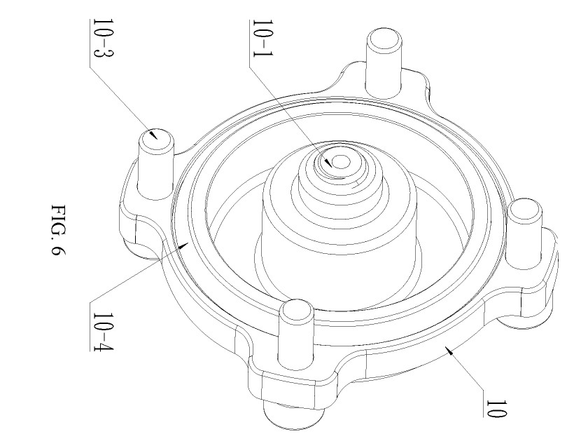

A large air cylinder 11 is mounted in the upper space of the gun housing 2. A small air cylinder 12 is fitted inside the large air cylinder 11. As shown in FIGS. 5-8, the rear end of the large air cylinder 11 is detachably mounted with a cylinder head 10 via cylinder head screws 10-3. The cylinder head 10 is configured to press and seal the rear end face of the small air cylinder 12. An internal thread 11-1 is arranged at the front end of the large air cylinder 11 for cooperation with the external thread 18-4 arranged on the cylinder connecting cover 18-1 to seal the large air cylinder 11 with the cylinder head base 18. A plurality of lugs 11-2 are evenly arranged along the circumferential direction on the outer wall of the rear end of the large air cylinder 11. The lugs 11-2 are provided with connecting holes 11-3, which are configured to match the cylinder head screws 10-3 on the cylinder head 10. The front end of the small air cylinder 12 is abutted against the cylinder head base 18 (the cylinder connecting cover 18-1), and the rear end of the small air cylinder 12 is provided with a through hole 12-3 that communicates with the large air cylinder 11, so that the large air cylinder 11 and the small air cylinder 12 cooperate to form a closed energy storage cavity.

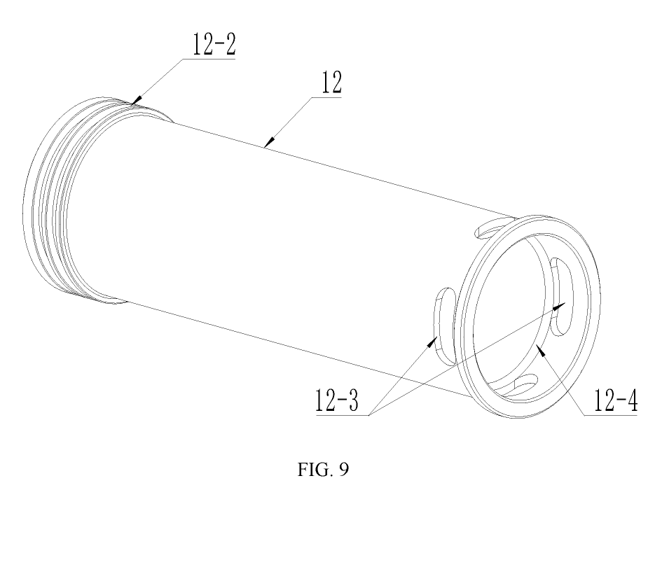

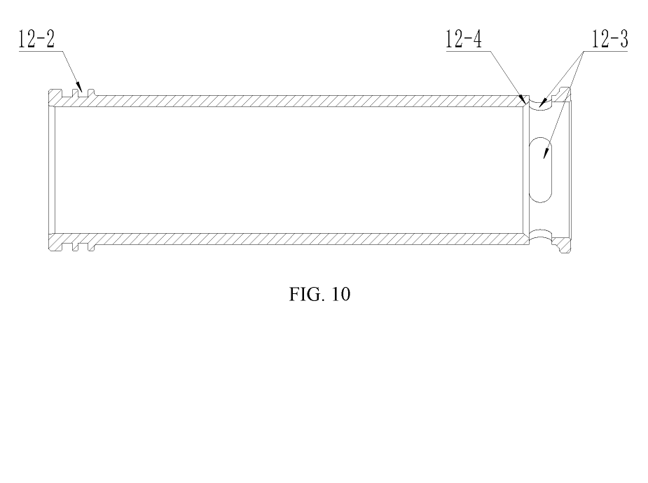

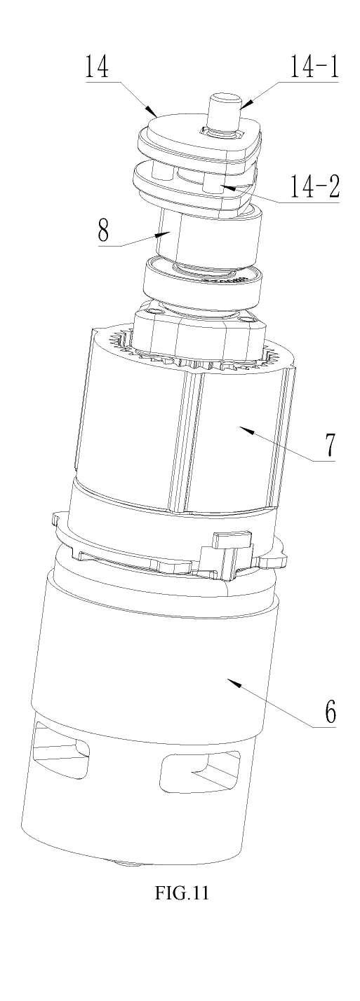

As shown in FIGS. 9 and 10, a small air cylinder sealing groove 12-2 is provided on the outer wall of the front end of the small air cylinder 12 for receiving a small air cylinder sealing ring 12-1. The small air cylinder sealing ring 12-1 contacts and seals with the inner wall of the large air cylinder 11. Four through holes 12-3 (preferably slotted holes) are evenly distributed along the circumferential direction on the outer wall of the rear end of the small air cylinder 12. A step 12-4 is provided along the circumferential direction on the inner side of the through holes 12-3, so that the inner diameter of the small air cylinder 12 at the through holes 12-3 is larger than the inner diameter at the step 12-4. When the small air cylinder is pulled by a tool engaged with the through hole, the radial surface of the small air cylinder will not be damaged, thereby extending the service life of the small air cylinder.

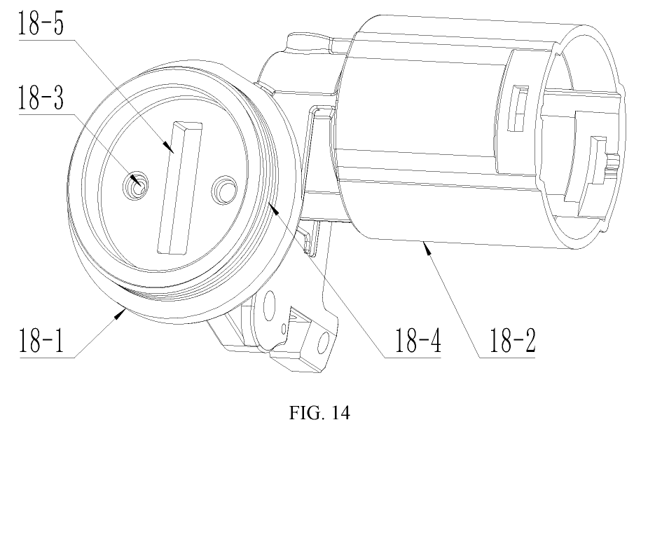

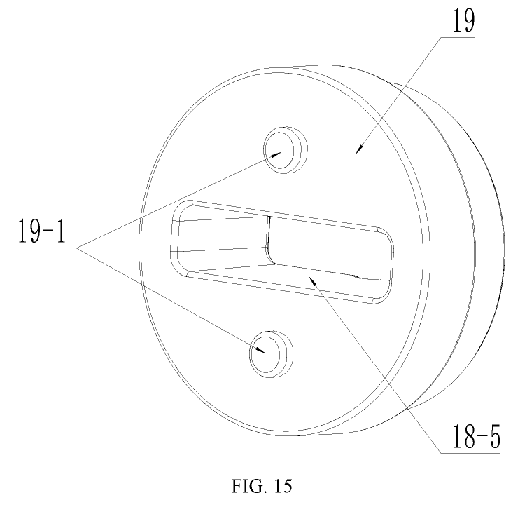

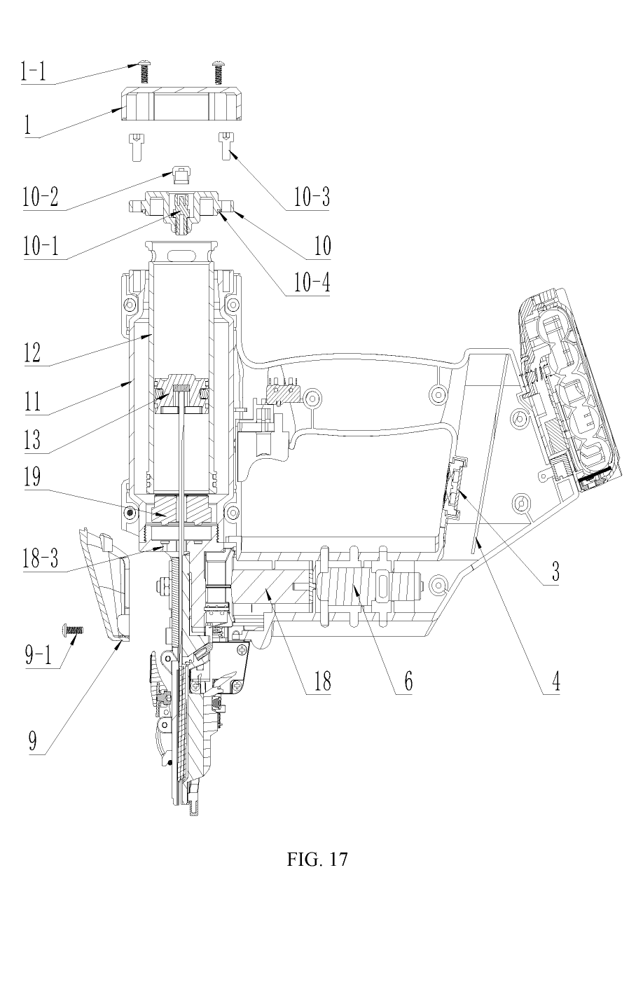

Referring to FIG. 2, the firing pin assembly 13 includes a firing pin body 13-2 and a piston 13-1 fixed to the rear end of the firing pin body 13-2. The piston 13-1 is slidably disposed in the energy storage chamber (small air cylinder 12), so that the air pressure in the energy storage chamber is adjusted between the initial pressure and the energy storage pressure. When the firing pin assembly 13 is fully released and the piston 13-1 is pressed against the buffer pad 19, the air pressure in the energy storage chamber is at the initial pressure. When the drive cam 14 drives the piston 13-1 to move and stop a set position, the air pressure in the energy storage chamber is at the energy storage pressure. As shown in FIGS. 14 and 15, the buffer pad 19 is provided between the cylinder connecting cover 18-1 and the small air cylinder 12 to provide cushioning for the piston 13-1. A firing pin slot 18-5 is provided on the buffer pad 19 and the cylinder connecting cover 18-1, so that the firing pin body 13-2 passes therethrough and extends into the firing pin track 15-1 in the assembly frame 15, so as to strike the nail in the assembly frame 15. Two cylinder head base holes are provided on the cylinder connecting cover 18-1, and two bosses 19-1 are correspondingly provided on the end face of the buffer pad 19 and configured to be embedded in the cylinder head base holes. One of the cylinder head base holes close to the decorative cover 9 is formed as a through hole, serving as the cylinder head base ejection hole 18-3. The decorative cover 9 is detachably mounted between the gun housing 2 and the assembly frame 15. As shown in FIG. 17, when the decorative cover 9 is removed, the cylinder head base ejection hole 18-3 is exposed on the cylinder connecting cover 18-1, facilitating ejection of the buffer pad 19 with a tool.

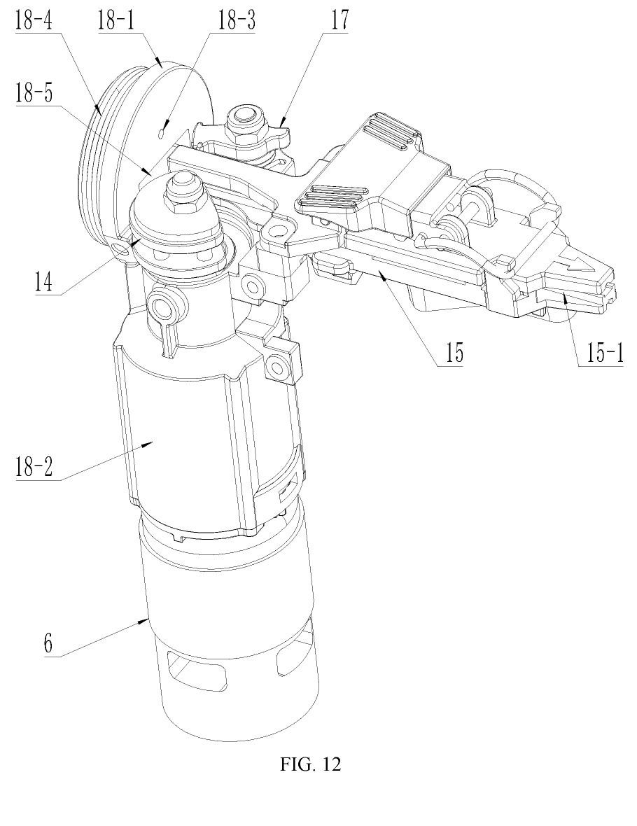

As shown in FIGS. 12-14, the cylinder head base 18 includes a cylinder connecting cover 18-1 detachably connected to the large air cylinder 11 and a motor connecting sleeve 18-2 for connecting a motor 6. A gearbox 7 is mounted inside the motor connecting sleeve 18-2. The output end of the motor 6 is configured to transmit power to a camshaft 14-1 after being reduced by the gearbox 7. A one-way bearing 8 is sleeved on the camshaft 14-1 so that the drive cam 14 is maintained in unidirectional rotation. The drive cam 14 is driven unidirectionally by the motor 6. Four cam pin shafts 14-2 are provided on the drive cam 14 to engage with the firing pin teeth 13-3 arranged on one side of the firing pin body 13-2, thereby driving the piston 13-1 to compress the gas in the energy storage chamber. The assembly frame 15 is fixedly mounted on the cylinder head base 18.

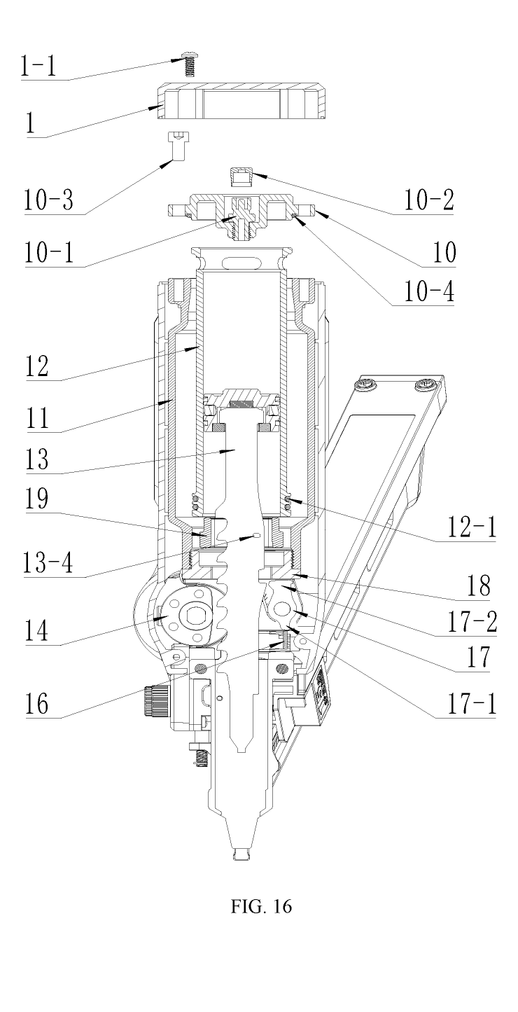

Referring to FIGS. 16 and 17, after the gun body top cover 1 is removed, the cylinder head 10 is exposed from the rear end of the gun housing 2. A valve core 10-1 is mounted at the center of the cylinder head 10 to communicate the external environment with the energy storage chamber and adjust the initial pressure in the energy storage chamber. After the cylinder head 10 is removed, the small air cylinder 12 is exposed from the rear end of the large air cylinder 11, facilitating the removal or replacement of the small air cylinder 12 and the firing pin assembly 13. One end of the valve core 10-1 communicates with the inner cavity of the small air cylinder 12, and the other end communicates with the external environment and is sealed with a valve core sealing cap 10-2. A cylinder head sealing ring 10-4 is mounted on the inner side of the cylinder head 10 to cooperate in sealing the end face of the large air cylinder 11. Preferably, as shown in FIGS. 2 and 16, a clutch pawl 17 is mounted on a side of the cylinder head base 18 facing away from the firing pin teeth 13-3 via a torsion spring. One end of the clutch pawl 17 is formed with a pawl head 17-2, and the other end is formed with a pawl toggling handle 17-1. When the drive cam 14 is rotated by one revolution and disengages from the firing pin tooth 13-3, the pawl head 17-2 is able to precisely engage with the corresponding notch on the firing pin body 13-2, maintaining the position of the firing pin body 13-2 and waiting for the drive cam 14 to continue rotating and reengage with the firing pin tooth 13-3. In addition, when it is necessary to disassemble the firing pin assembly 13, the clutch pawl 17 is toggled by the pawl toggling handle 17-1, so that the pawl head 17-2 is disengaged from the notch on the firing pin body 13-2, facilitating the complete removal of the firing pin assembly 13. A sensing optocoupler 16 is arranged near the mounting position of the clutch pawl 17. The sensing optocoupler 16 cooperates with an optocoupler sensing notch 13-4 on the firing pin body 13-2 (the small hole on the firing pin body 13-2 in FIG. 16) in order to detect and determine the position of the firing pin body 13-2 (firing pin assembly 13). In addition, the sensing optocoupler 16 is configured to send a position information to the control circuit board 4.

Furthermore, a mode switching setting switch 3 is mounted on the surface of the gun housing 2, and a control circuit board 4 is mounted in the lower space of the gun housing 2. The mode switching setting switch 3 is electrically connected to the control circuit board 4. The mode switching setting switch 3 is configured to set the operating mode position and send an operating mode position signal to the control circuit board 4. The operating mode positions include a normal operating position and a maintenance position. At the normal operating position, after the firing pin assembly 13 is fully released, the gas in the energy storage chamber returns to the initial pressure. The control circuit board 4 controls the drive cam 14 to drive the firing pin assembly 13 to compress the gas in the energy storage chamber. When the pressure reaches the energy storage pressure, the control circuit board 4 controls the drive cam 14 to stop rotating, and the one-way bearing 8 holds the firing pin assembly 13 at a preset position to maintain the energy storage pressure. At the maintenance position, after the firing pin assembly 13 is fully released, the control circuit board 4 controls the drive cam 14 to stop operating, and the gas in the energy storage chamber is maintained at the initial pressure, thereby facilitating subsequent disassembly and maintenance.

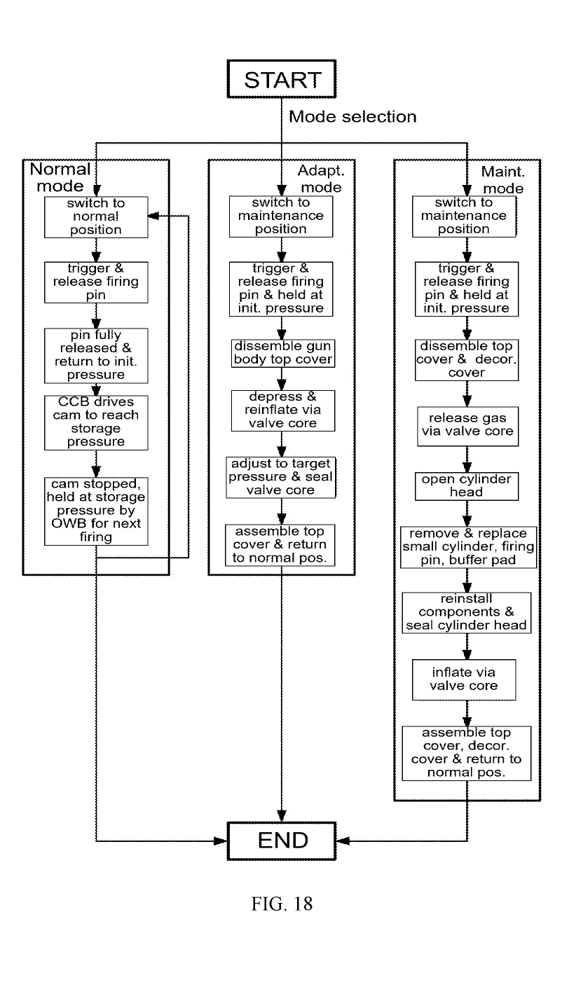

As another aspect of this embodiment, as shown in FIG. 18, a method for adapting and maintaining a nail gun in multiple operating conditions is provided, which adopts the above-mentioned nail gun adaptable to multiple operating conditions and facilitating maintenance, and the method includes the following operating modes:

In a normal mode: the mode switching setting switch 3 is set to the normal operating position and the trigger of the nail gun is actuated, and after the firing pin assembly 13 is fully released, the gas in the energy storage chamber returns to the initial pressure; the control circuit board 4 controls the drive cam 14 to drive the firing pin assembly 13 to compress and pressurize the gas in the energy storage chamber; when the pressure reaches the energy storage pressure, the control circuit board 4 controls the drive cam 14 to stop rotating, and the one-way bearing 8 holds the firing pin assembly 13 at the preset position to maintain the energy storage pressure; and when the nail gun is triggered again, the firing pin assembly 13 is released to strike the nail, realizing a cyclic operation.

In an adaptation mode: the mode switching setting switch 3 is set to the maintenance position and the trigger of the nail gun is actuated, and after the firing pin assembly 13 is fully released, the control circuit board 4 controls the drive cam 14 to stop operating and disengage from the firing pin assembly 13, so that the drive cam 14 no longer drives the firing pin assembly 13 to return; the gas in the energy storage chamber is maintained at its initial pressure, at this time, the gun body top cover 1 is removed, the valve core sealing cap 10-2 on the cylinder head 10 is unscrew, and the valve core 10-1 is removed to release the gas in the energy storage chamber, an external air source is connected to the valve core 10-1 to inflate the energy storage chamber, and the inflation pressure is adjusted according to the actual operating conditions to change the initial pressure of the energy storage chamber; after completion, the valve core sealing cap 10-2 is tightened, the gun body top cover 1 is covered, and the mode switching setting switch 3 is switched back to the normal operating position; preferably, when driving hard materials and long nails, the inflation pressure is appropriately increased, and when driving soft materials and short nails, the inflation pressure is appropriately decreased, namely the inflation pressure when driving hard materials and long nails is greater than the inflation pressure when driving soft materials and short nails, thereby preventing the nail from penetrating the wood or wall when driving soft materials or short nails, and preventing the nail from being completely driven into the wood or wall when driving hard materials or long nails.

In a maintenance mode: the mode switching setting switch 3 is set to the maintenance position, and the trigger of the nail gun is actuated, and after the firing pin assembly 13 is fully released, the control circuit board 4 controls the drive cam 14 to stop operating and disengage from the firing pin assembly 13, so that the drive cam 14 no longer drives the firing pin assembly 13 to return; the gas in the energy storage chamber is maintained at the initial pressure, at this time, the gun body top cover 1 and decorative cover 9 are removed, the valve core sealing cap 10-2 is unscrewed, and the valve core 10-1 is removed to release the gas in the energy storage chamber, and then the cylinder head 10 is opened, and the small air cylinder 12, the firing pin assembly 13 and the buffer pad 19 in the energy storage chamber are removed in sequence for replacement; preferably, the small air cylinder 12 is removed by pulling along the axial direction with a special tool engaged with the through hole 12-3, and since the inner diameter of the small air cylinder 12 at the through holes 12-3 is larger than the inner diameter at the step 12-4, when the small air cylinder is pulled out using the tool engaged with the through hole, the radial surface of the small air cylinder is not be damaged, thereby extending the service life of the small air cylinder; during mounting, the buffer pad 19 is first mounted, the small air cylinder 12 with the small air cylinder seal ring 12-1 is inserted into the large air cylinder 11, the clutch pawl 17 is disengaged to avoid the firing pin body 13-2, then the firing pin assembly 13 is mounted and pushed fully into position, after that the cylinder head 10 is covered, and the energy storage chamber is inflated through the valve core 10-1, after inflation, the valve core sealing cap 10-2 is tightened, the gun body top cover 1 and decorative cover 9 are mounted, and the mode switching setting switch 3 is switched back to the normal operating position.

It is understood that, for those skilled in the art, any equivalent substitutions or modifications to the technical proposals and inventive concepts of the present disclosure should fall within the scope of protection of the appended claims.

What is claimed is:

1. A nail gun adaptable to multiple operating conditions and facilitating maintenance, comprising:
a housing assembly, including a gun housing (2), an assembly frame (15) disposed at a front end of the gun housing (2), and a gun body top cover (1) detachably mounted on a rear end of the gun housing (2), a nail magazine (5) being connected to a lower part of the assembly frame (15);
an energy storage chamber, including a large air cylinder (11) disposed inside the gun housing (2) and a small air cylinder (12) inserted inside the large air cylinder (11), a cylinder head (10) being detachably mounted at a rear end of the large air cylinder (11) and configured to press and seal a rear end of the small air cylinder (12), a cylinder head base (18) being mounted at a front end of the large air cylinder (11) for sealing, and a front end of the small air cylinder (12) being abutted against the cylinder head base (18), a through hole (12-3) communicating with the large air cylinder (11) being opened at the rear end of the small air cylinder (12), so that the large air cylinder (11) and the small air cylinder (12) cooperate to form the energy storage chamber which is closed;
a firing pin assembly (13), including a firing pin body (13-2) and a piston (13-1) fixed to a rear end of the firing pin body (13-2), the piston (13-1) being slidably disposed in the energy storage chamber, so as to adjust an air pressure in the energy storage chamber between an initial pressure and an energy storage pressure, a front end of the firing pin body (13-2) passing through the cylinder head base (18) and extending into the assembly frame (15) for striking a nail in the assembly frame (15);
the cylinder head base (18), including a cylinder connecting cover (18-1) detachably connected to the large air cylinder (11) and a motor connecting sleeve (18-2) for connecting a motor (6), the assembly frame (15) being fixed to the cylinder head base (18); and
a drive cam (14), driven unidirectionally by the motor (6) and being provided with a plurality of cam pin shafts (14-2), the cam pin shafts being configured to engage with firing pin teeth (13-3) arranged on the firing pin body (13-2), thereby driving the piston (13-1) to compress the gas in the energy storage chamber;
wherein the gun body top cover (1) is configured to, when removed, expose the cylinder head (10) from the rear end of the gun housing (2), a valve core (10-1) is mounted on the cylinder head (10) to communicate an external environment with the energy storage chamber and adjust the initial pressure in the energy storage chamber, the cylinder head (10) is configured to, when removed, expose the small air cylinder (12) from the rear end of the large air cylinder (11), thereby facilitating removal or replacement of the small air cylinder (12) and firing pin assembly (13).

2. The nail gun adaptable to multiple operating conditions and facilitating maintenance according to claim 1, wherein a buffer pad (19) is disposed between the cylinder connecting cover (18-1) and the small air cylinder (12) for providing cushioning to the piston (13-1); the buffer pad (19) and the cylinder connecting cover (18-1) are each provided with a firing pin slot (18-5) through which the firing pin body (13-2) passes and extends into a firing pin track (15-1) in the assembly frame (15).

3. The nail gun adaptable to multiple operating conditions and facilitating maintenance according to claim 2, wherein the cylinder connecting cover (18-1) is provided with a plurality of cylinder head base holes, and bosses (19-1) are arranged on an end face of the buffer pad (19) and configured to be embedded and mounted in the cylinder head base holes, at least one of the cylinder head base holes close to a decorative cover (9) is formed as a through hole, serving as a cylinder head base ejection hole (18-3), the decorative cover (9) is detachably mounted between the gun housing (2) and the assembly frame (15) and, when removed, exposes the cylinder connecting cover (18-1) through the cylinder head base ejection hole (18-3), thereby facilitating ejection of the buffer pad (19).

4. The nail gun adaptable to multiple operating conditions and facilitating maintenance according to claim 1, wherein a gearbox (7) is arranged inside the motor connecting sleeve (18-2), an output end of the motor (6) is configured to transmit power to a camshaft (14-1) after being reduced by the gearbox (7), a one-way bearing (8) is sleeved on the camshaft (14-1) so that the drive cam (14) is maintained in unidirectional rotation.

5. The nail gun adaptable to multiple operating conditions and facilitating maintenance according to claim 4, further comprising a mode switching setting switch (3) mounted on the surface of the gun housing (2), and a control circuit board (4) mounted inside the gun housing (2), wherein the mode switching setting switch (3) is electrically connected to the control circuit board (4) and is configured to set an operating position and send an operating position signal to the control circuit board (4), the operating position includes a normal operating position and a maintenance position: in the normal operating position, after the firing pin assembly (13) is fully released, the gas in the energy storage chamber returns to the initial pressure, the control circuit board (4) controls the drive cam (14) to drive the firing pin assembly (13) so as to compress and pressurize the gas in the energy storage chamber, and the control circuit board (4) controls the drive cam (14) to stop rotating when the pressure reaches the energy storage pressure, and the firing pin assembly (13) is held in a preset position by the one-way bearing (8) to maintain the energy storage pressure; and in the maintenance position, after the firing pin assembly (13) is fully released, the control circuit board (4) controls the drive cam (14) to stop operating, and the gas in the energy storage chamber remains at the initial pressure.

6. The nail gun adaptable to multiple operating conditions and facilitating maintenance according to claim 1, wherein the front end of the large air cylinder (11) is provided with an internal thread (11-1) that cooperates with an external thread (18-4) on the cylinder connecting cover (18-1), and a plurality of lugs (11-2) are evenly arranged along a circumferential direction on an outer wall of the rear end of the large air cylinder (11), each provided with a connecting hole (11-3) for cooperating with cylinder head screws (10-3) arranged on the cylinder head (10).

7. The nail gun adaptable to multiple operating conditions and facilitating maintenance according to claim 1, wherein an end of the valve core (10-1) is communicated with an inner cavity of the small air cylinder (12), and the other end of the valve core (10-1) is communicated with the external environment and sealed with a valve core sealing cap (10-2), a cylinder head sealing ring (10-4) is mounted on an inner side of the cylinder head (10) to cooperate in sealing an end face of the large air cylinder (11).

8. The nail gun adaptable to multiple operating conditions and facilitating maintenance according to claim 6, wherein an end of the valve core (10-1) is communicated with an inner cavity of the small air cylinder (12), and the other end of the valve core (10-1) is communicated with the external environment and sealed with a valve core sealing cap (10-2), a cylinder head sealing ring (10-4) is mounted on an inner side of the cylinder head (10) to cooperate in sealing an end face of the large air cylinder (11).

9. The nail gun adaptable to multiple operating conditions and facilitating maintenance according to claim 1, wherein a small air cylinder sealing groove (12-2) is provided on an outer wall at the front end of the small air cylinder (12) for receiving a small air cylinder sealing ring (12-1), and the small air cylinder sealing ring (12-1) is in contact with an inner wall of the large air cylinder (11) in a sealing manner, a plurality of through holes (12-3) are evenly distributed along the circumferential direction on an outer wall at the rear end of the small air cylinder (12), and a step (12-4) is arranged along an circumferential direction on an inner side of the through holes (12-3), so that an inner diameter of the small air cylinder (12) at the through holes (12-3) is larger than an inner diameter thereof at the step (12-4).

10. A method for adapting and maintaining a nail gun in multiple operating conditions, adopting a nail gun adaptable to multiple operating conditions and facilitating maintenance, the nail gun comprising:
a housing assembly, including a gun housing (2), an assembly frame (15) disposed at a front end of the gun housing (2), and a gun body top cover (1) detachably mounted on a rear end of the gun housing (2), a nail magazine (5) being connected to a lower part of the assembly frame (15);
an energy storage chamber, including a large air cylinder (11) disposed inside the gun housing (2) and a small air cylinder (12) inserted inside the large air cylinder (11), a cylinder head (10) being detachably mounted at a rear end of the large air cylinder (11) and configured to press and seal a rear end of the small air cylinder (12), a cylinder head base (18) being mounted at a front end of the large air cylinder (11) for sealing, and a front end of the small air cylinder (12) being abutted against the cylinder head base (18), a through hole (12-3) communicating with the large air cylinder (11) being opened at the rear end of the small air cylinder (12), so that the large air cylinder (11) and the small air cylinder (12) cooperate to form the energy storage chamber which is closed;
a firing pin assembly (13), including a firing pin body (13-2) and a piston (13-1) fixed to a rear end of the firing pin body (13-2), the piston (13-1) being slidably disposed in the energy storage chamber, so as to adjust an air pressure in the energy storage chamber between an initial pressure and an energy storage pressure, a front end of the firing pin body (13-2) passing through the cylinder head base (18) and extending into the assembly frame (15) for striking a nail in the assembly frame (15);
the cylinder head base (18), including a cylinder connecting cover (18-1) detachably connected to the large air cylinder (11) and a motor connecting sleeve (18-2) for connecting a motor (6), the assembly frame (15) being fixed to the cylinder head base (18); and
a drive cam (14), driven unidirectionally by the motor (6) and being provided with a plurality of cam pin shafts (14-2), the cam pin shafts being configured to engage with firing pin teeth (13-3) arranged on the firing pin body (13-2), thereby driving the piston (13-1) to compress the gas in the energy storage chamber;
wherein the gun body top cover (1) is configured to, when removed, expose the cylinder head (10) from the rear end of the gun housing (2), a valve core (10-1) is mounted on the cylinder head (10) to communicate an external environment with the energy storage chamber and adjust the initial pressure in the energy storage chamber, the cylinder head (10) is configured to, when removed, expose the small air cylinder (12) from the rear end of the large air cylinder (11), thereby facilitating removal or replacement of the small air cylinder (12) and firing pin assembly (13);
the method comprising the following operating modes:
a normal operating mode: wherein the mode switching setting switch (3) is set to the normal operating position and a trigger of the nail gun is actuated, after the firing pin assembly (13) is fully released, the gas in the energy storage chamber returns to the initial pressure, the control circuit board (4) controls the drive cam (14) to drive the firing pin assembly (13) so as to compress and pressurize the gas in the energy storage chamber, when the pressure reaches the energy storage pressure, the control circuit board (4) controls the drive cam (14) to stop rotating, and the one-way bearing (8) holds the firing pin assembly (13) at a preset position to maintain the energy storage pressure, upon a subsequent actuation of the trigger of the nail gun, the firing pin assembly (13) is released to strike the nail, thereby enabling cyclic operation;
an adaptation mode: wherein the mode switching setting switch (3) is set to the maintenance position and the trigger of the nail gun is actuated, after the firing pin assembly (13) is fully released, the control circuit board (4) controls the drive cam (14) to stop operating and disengage from the firing pin assembly (13), such that the drive cam (14) no longer drives the firing pin assembly (13) to return, the gas in the energy storage chamber is maintained at the initial pressure, at this time, the gun body top cover (1) is removed and the valve core sealing cap (10-2) on the cylinder head (10) is unscrewed to release the valve core (10-1), thereby releasing the gas in the energy storage chamber, an external air source is connected to the valve core (10-1) to inflate the energy storage chamber, and the inflation pressure is adjusted according to actual operating conditions to change the initial pressure in the energy storage chamber, after completion, the valve core sealing cap (10-2) is tightened, the gun body top cover (1) is mounted, and the mode switching setting switch (3) is returned to the normal operating position; and
a maintenance mode: wherein the mode switching setting switch (3) is set to the maintenance position and the trigger of the nail gun is actuated, after the firing pin assembly (13) is fully released, the control circuit board (4) controls the drive cam (14) to stop operating and disengage from the firing pin assembly (13), such that the drive cam (14) no longer drives the firing pin assembly (13) to return, the gas in the energy storage chamber is maintained at the initial pressure, at this time, the gun body top cover (1) and the decorative cover (9) are removed, and the valve core sealing cap (10-2) is unscrewed to release the valve core (10-1), thereby releasing the gas in the energy storage chamber, then the cylinder head (10) is opened, and the small air cylinder (12), the firing pin assembly (13), and the buffer pad (19) in the energy storage chamber are sequentially removed for replacement, and during assembly, the buffer pad (19) is first mounted, then the small air cylinder (12) is inserted into the large air cylinder (11), and the firing pin assembly (13) is mounted and pushed fully into position, then the cylinder head (10) is mounted, and the energy storage chamber is inflated via the valve core (10-1), after inflation, the valve core sealing cap (10-2) is tightened, the gun body top cover (1) and the decorative cover (9) are mounted, and the mode switching setting switch (3) is returned to the normal operating position.

11. The method for adapting and maintaining a nail gun in multiple operating conditions according to claim 10, wherein in the adaptation mode, an inflation pressure for driving a hard material and a long nail is greater than an inflation pressure for driving a soft material and a short nail; an in the maintenance mode, the small air cylinder (12) is removed by engaging a tool with the through hole (12-3) and pulling the small air cylinder (12) along an axial direction.

12. The method for adapting and maintaining a nail gun in multiple operating conditions according to claim 10, wherein a buffer pad (19) is disposed between the cylinder connecting cover (18-1) and the small air cylinder (12) for providing cushioning to the piston (13-1); the buffer pad (19) and the cylinder connecting cover (18-1) are each provided with a firing pin slot (18-5) through which the firing pin body (13-2) passes and extends into a firing pin track (15-1) in the assembly frame (15); and
wherein the cylinder connecting cover (18-1) is provided with a plurality of cylinder head base holes, and bosses (19-1) are arranged on an end face of the buffer pad (19) and configured to be embedded and mounted in the cylinder head base holes, at least one of the cylinder head base holes close to a decorative cover (9) is formed as a through hole, serving as a cylinder head base ejection hole (18-3), the decorative cover (9) is detachably mounted between the gun housing (2) and the assembly frame (15) and, when removed, exposes the cylinder connecting cover (18-1) through the cylinder head base ejection hole (18-3), thereby facilitating ejection of the buffer pad (19).

13. The method for adapting and maintaining a nail gun in multiple operating conditions according to claim 12, wherein in the adaptation mode, an inflation pressure for driving a hard material and a long nail is greater than an inflation pressure for driving a soft material and a short nail; an in the maintenance mode, the small air cylinder (12) is removed by engaging a tool with the through hole (12-3) and pulling the small air cylinder (12) along an axial direction.

14. The method for adapting and maintaining a nail gun in multiple operating conditions according to claim 10, wherein a gearbox (7) is arranged inside the motor connecting sleeve (18-2), an output end of the motor (6) is configured to transmit power to a camshaft (14-1) after being reduced by the gearbox (7), a one-way bearing (8) is sleeved on the camshaft (14-1) so that the drive cam (14) is maintained in unidirectional rotation; and
wherein the nail gun further comprises a mode switching setting switch (3) mounted on the surface of the gun housing (2), and a control circuit board (4) mounted inside the gun housing (2), wherein the mode switching setting switch (3) is electrically connected to the control circuit board (4) and is configured to set an operating position and send an operating position signal to the control circuit board (4), the operating position includes a normal operating position and a maintenance position: in the normal operating position, after the firing pin assembly (13) is fully released, the gas in the energy storage chamber returns to the initial pressure, the control circuit board (4) controls the drive cam (14) to drive the firing pin assembly (13) so as to compress and pressurize the gas in the energy storage chamber, and the control circuit board (4) controls the drive cam (14) to stop rotating when the pressure reaches the energy storage pressure, and the firing pin assembly (13) is held in a preset position by the one-way bearing (8) to maintain the energy storage pressure; and in the maintenance position, after the firing pin assembly (13) is fully released, the control circuit board (4) controls the drive cam (14) to stop operating, and the gas in the energy storage chamber remains at the initial pressure.

15. The method for adapting and maintaining a nail gun in multiple operating conditions according to claim 14, wherein in the adaptation mode, an inflation pressure for driving a hard material and a long nail is greater than an inflation pressure for driving a soft material and a short nail; an in the maintenance mode, the small air cylinder (12) is removed by engaging a tool with the through hole (12-3) and pulling the small air cylinder (12) along an axial direction.

16. The method for adapting and maintaining a nail gun in multiple operating conditions according to claim 10, wherein the front end of the large air cylinder (11) is provided with an internal thread (11-1) that cooperates with an external thread (18-4) on the cylinder connecting cover (18-1), and a plurality of lugs (11-2) are evenly arranged along a circumferential direction on an outer wall of the rear end of the large air cylinder (11), each provided with a connecting hole (11-3) for cooperating with cylinder head screws (10-3) arranged on the cylinder head (10); and
wherein an end of the valve core (10-1) is communicated with an inner cavity of the small air cylinder (12), and the other end of the valve core (10-1) is communicated with the external environment and sealed with a valve core sealing cap (10-2), a cylinder head sealing ring (10-4) is mounted on an inner side of the cylinder head (10) to cooperate in sealing an end face of the large air cylinder (11).

17. The method for adapting and maintaining a nail gun in multiple operating conditions according to claim 16, wherein in the adaptation mode, an inflation pressure for driving a hard material and a long nail is greater than an inflation pressure for driving a soft material and a short nail; an in the maintenance mode, the small air cylinder (12) is removed by engaging a tool with the through hole (12-3) and pulling the small air cylinder (12) along an axial direction.

18. The method for adapting and maintaining a nail gun in multiple operating conditions according to claim 10, wherein a small air cylinder sealing groove (12-2) is provided on an outer wall at the front end of the small air cylinder (12) for receiving a small air cylinder sealing ring (12-1), and the small air cylinder sealing ring (12-1) is in contact with an inner wall of the large air cylinder (11) in a sealing manner, a plurality of through holes (12-3) are evenly distributed along the circumferential direction on an outer wall at the rear end of the small air cylinder (12), and a step (12-4) is arranged along an circumferential direction on an inner side of the through holes (12-3), so that an inner diameter of the small air cylinder (12) at the through holes (12-3) is larger than an inner diameter thereof at the step (12-4).

19. The method for adapting and maintaining a nail gun in multiple operating conditions according to claim 18, wherein in the adaptation mode, an inflation pressure for driving a hard material and a long nail is greater than an inflation pressure for driving a soft material and a short nail; an in the maintenance mode, the small air cylinder (12) is removed by engaging a tool with the through hole (12-3) and pulling the small air cylinder (12) along an axial direction.
